(19) United States
(12) Patent Application Publication
(10) Pub. No.: US 2009/0021699 A1
(43) Pub. Date: Jan. 22, 2009

(54) Color management system

(75) Inventors: Chien-Wen Hsu, Tu-Cheng (TW); Chia-Hung Kao, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/953,675

(22) Filed: Dec. 10, 2007

(30) Foreign Application Priority Data
Jul. 20, 2007 (CN) 200710201147.7

(51) Int. Cl. G03B 21/14

(52) U.S. Cl. 353/20

(57) ABSTRACT

A color management system includes a light combiner configured for producing a single light output, a color selector positioned to receive the combined light output and configured for selectively modifying the polarization of the combined light output according to the wavelength of the combined light output, an analyzer positioned to receive the emergent light of the color selector and configured for producing an output light having an improved contrast relative to the emergent light of the color selector. An improved color management system is provided that improves image contrast and facilitates color management suitable for use in adverse thermal environments without requiring costly, high index, low birefringence glass via coupling the color selector and the analyzer to the light combiner.

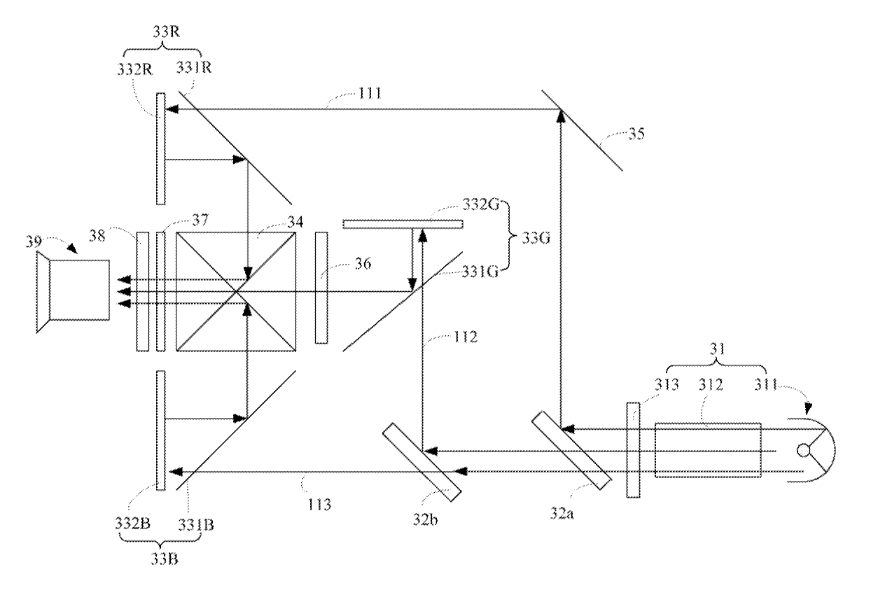

### RELATED FIELD

The present invention relates generally to color management systems for projection displays, and more specifically to a system for facilitating projection of a high-contrast, full color image.

### BACKGROUND

In conjunction with a projection display, it is desirable to employ a color management system. It is further desirable that such color management system facilitates the production of a high contrast image while accommodating a relatively high level of illuminating flux. In general, current color management systems are capable of achieving increased contrast at practical levels of illuminating flux only by employing highly specialized materials. This makes the cost of such systems unattractive.

Many color management systems use solid “cube-type” polarizing beam-splitters for separation and recombination of incident light beams. These polarizing beam-splitters are otherwise referred to as MacNeille prisms or cube polarizing beam-splitters. “Cube type” polarizing beam-splitters are inherently susceptible to thermal gradients that typically arise at high flux levels. That is, at higher temperatures, stress birefringence often occurs with such beam-splitters. This results in depolarization of light and a loss of contrast. Thus, when high contrast images are desired, costly high-index, low-birefringence glass needs to be used. This solution has proven effective to reduce birefringence at low levels of flux. However the solution is expensive, and still has limited effectiveness in eliminating thermally induced birefringence at high flux levels.

It is desired to provide a color management system which can overcome the above-described deficiencies.

### SUMMARY

In accordance with an exemplary embodiment, a color management system includes a light combiner, a color selector, and an analyzer. The light combiner is configured for receiving a plurality of light inputs and producing a single light output. The color selector is positioned to receive the combined light output, and selectively modify the polarization direction of the combined light output according to wavelengths of the combined light output. The analyzer is positioned to receive the modified light output from the color selector, and produce output light having improved contrast relative to the received modified light.

Other novel features and advantages will become more apparent from the following detailed description when taken in conjunction with the accompanying drawing.

### BRIEF DESCRIPTION OF THE DRAWING

The present invention is described in detail hereinafter, by way of example and through description of preferred and exemplary embodiments with reference to the accompanying drawing in which:

The drawing illustrates a color management system in accordance with an exemplary embodiment of the present invention.

### DETAILED DESCRIPTION OF THE PREFERRED EMBODIMENTS

A detailed explanation of a color management system for projection displays according to various embodiments of the present invention will now be made with reference to the drawing attached hereto.

Referring to the drawing, a color management system typically used in a liquid crystal on silicon (LCOS) projector is illustrated. The color management system includes a light source assembly 31, a first light separator 32a, a second light separator 32b, a first image assimilator 33R, a second image assimilator 33G, a third image assimilator 33B, a light combiner 34, a mirror 35, a retarder 36, a color selector 37, an analyzer 38, and a projecting lens 39.

It should be noted that the color management system can also be used in other kinds of projectors, for example a liquid crystal display (LCD) projector. In the present embodiment, the LCOS projector is presented only as an example to explain working principles of the color management system.

The light source assembly 31 includes a light source 311, an integrator 312 disposed in a light path of light emerging from the light source 311, and a polarization conversion system (hereinafter called a converter) 313 disposed in a path of light output from the integrator 312. The light source 311 can be a halogen lamp, a metal halogen lamp, a light emitting diode (LED), and the like. In the present embodiment, the light source 311 is a halogen lamp that emits white light. The integrator 312 is configured for effectively collecting the light from the light source 311 and outputting the light uniformly. The converter 313 is configured for converting the light from the integrator 312 into P-wave light or S-wave light. In the present embodiment, the converter 313 converts the white light from the integrator 312 into P-wave light and outputs the P-wave light.

The first light separator 32a receives a light beam originating from the light source assembly 31, separates the light beam into two or more light components and outputs the two or more light components. In the present embodiment, the first light separator 32a is positioned to receive a light beam comprising a first component 111, a second component 112, and a third component 113. The first, second, and third components 111, 112 and 113 can be red, green, and blue components. In the present embodiment, the first component 111 is a red component, the second component 112 is a green component and the third component 113 is a blue component. The first light separator 32a is configured for reflecting the first component 111, and transmitting the second component 112 and the third component 113. The second separator 32b is positioned to receive the second and third components 112, 113 transmitted by the first separator 32a. The second separator 32b is configured for reflecting the second component 112 and transmitting the third component 113. Each of the first and second separators 32a, 32b can be a dichroic mirror, a dichroic beam-splitter, or a plate dichroic prism coupled with an optical retarder. In the present embodiment, the first and second separators 32a, 32b are dichroic mirrors.

The mirror 35 is disposed between the first light separator 32a and the first image assimilator 33R. In particular, the mirror 35 is positioned to receive the first component 111 reflected by the first light separator 32a, and reflect the first component 111 to the first light assimilator 33R.

The first image assimilator 33R is positioned to receive the first component 111, and is configured for superimposing spatial information on the first component 111 so as to produce a light beam that includes spatial information. The first image assimilator 33R includes a polarizing beam splitter (PBS) 331R and a spatial light modulator 332R. The PBS 331R can be a wire gird polarizer (WGP) or a polarization beam splitter prism. In the present embodiment, the PBS 331R is a WGP. The first component 111 transmits directly through the PBS 331R and reaches the spatial light modulator 332R. The spatial light modulator 332R can be a liquid crystal on silicon (LCOS) panel. The spatial light modulator 332R is configured for modifying the polarization direction of the first component 111 in a predetermined manner and superimposing spatial information on the first components 111. The spatial light modulator 332R outputs the first component 111 with a polarization direction that is substantially orthogonal to the polarization direction of the first component 111 as input to the spatial light modulator 332R. The modified first component 111 is reflected by the PBS 331R to the light combiner 34.

As indicated above, the second and third components 112, 113 are separated by the second light separator 32b. The second component 112 is reflected by the second light separator 32b to the second image assimilator 33G. The third component 113 transmits directly through the second light separator 32b to the third image assimilator 33B. The second and third image assimilators 33G, 33B are configured for respectively modifying the polarization direction of the second and third components 112, 113 in a predetermined manner and superimposing spatial information on the second and third components 112, 113 so as to produce light beams that include spatial information, and transmitting the modified second and third components 112, 113 to the light combiner 34. It should be noted that the second and third image assimilators 33G, 33B respectively include polarizing beam splitters 331G, 331B and spatial light modulators 332G, 332B. The spatial information superimposed on the second and third components 112, 113 is the same as the spatial information superimposed on the first component 111 by the first image assimilator 33R.

The retarder 36 is disposed between the second image assimilator 33G and the light combiner 34. The retarder 36 is configured for converting the polarization direction of the second component 112. In particular, the polarization direction of the second component 112 when it exits the retarder 36 is substantially orthogonal to the polarization direction of the second component 112 when it enters the retarder 36. The retarder 36 is typically a half-wave retarder. Alternatively, the retarder 36 can include two overlapped quarter-wave retarders.

The light combiner 34 is disposed in the path of the light output from the first, second, and third image assimilators 33R, 33G, 33B and is configured for combining the first, second and third components 111, 112, 113 to produce a single light output. The light combiner 34 can be a dichroic beam splitter or an X-prism. Where the light combiner 34 is an X-prism, it may include one or more dichroic filters and may also include a polarizing beam splitter. It should be noted that the X-prism is an optical element having two internal planes that lie substantially orthogonal to one another. In the present embodiment, the two planes are dichroic filters configured for substantially transmitting light having a first wavelength and substantially reflecting light having a second wavelength.

The color selector 37 is disposed in the path of the light output from the light combiner 34. The color selector 37 is configured for selectively modifying the polarization direction of the first, second, and third components 111, 112 113 according to their wavelengths so that the light output from the color selector 38 is linearly polarized, with the polarization direction for each color band is substantially the same as that of each of the other color bands. In the present embodiment, the color selector 38 modifies the polarization direction of the third component 113.

The analyzer 38 is positioned to receive the light output from the color selector 36. As one example, the analyzer 38 can be a polarizer. The analyzer 38 is configured for substantially transmitting spatial information. The analyzer 38 is also configured for preventing or minimizing transmission of noise imparted by the first, second and third image assimilators 33R, 33B, 33G to the first, second and third component 111, 112, 113, thereby producing output light having improved contrast. The noise includes substantially non-polarized light or polarized light that is not oriented in the same manner as the spatial information.

The projecting lens 39 is configured for outputting light containing spatial information for magnifying the light output and projecting an image on a screen (not shown).

The above-described color management system improves image contrast and facilitates color management, and is suitable for use in adverse thermal environments. The color management system utilizes coupling of the color selector 37 and the analyzer 38 to the light combiner 34 to achieve good image quality, without requiring costly, high index, low birefringence glass.

It should be understood that the above-described embodiments are intended to illustrate rather than limit the invention. Variations may be made to the embodiments without departing from the spirit of the invention. Accordingly, it is appropriate that the appended claims be construed broadly and in a manner consistent with the scope of the invention.

What is claimed is:

1. A color management system comprising:
a light combiner configured for receiving a plurality of light inputs and producing a combined light output;
a color selector positioned to receive the combined light output and selectively modify the polarization direction of the combined light output according to wavelengths of the combined light output; and
an analyzer positioned to receive the modified light output from the color selector, and produce output light having improved contrast relative to the received modified light.

2. The color management system claimed in claim 1, wherein the analyzer is a polarizer.

3. The color management system claimed in claim 1, further comprising a projection lens positioned to receive the output light of the analyzer and project an image.

4. The color management system claimed in claim 1, further comprising a retarder disposed in the path of the light inputs input the light combiner.

5. The color management system claimed in claim 5, wherein the retarder is a half-wave retarder.

6. The color management system claimed in claim 5, where the retarder comprises two overlapped quarter-wave retarders.

7. The color management system claimed in claim 1, further comprising three image assimilators respectively disposed in the three paths of three of the plurality of light inputs input to the light combiner.

8. The color management system claimed in claim 7, wherein each of the image assimilators comprises a polarization beam splitter and a spatial light modulator.

9. The color management system claimed in claim 8, wherein for each of the image assimilators, the polarization beam splitter is of a wire grid polarizer and a polarization beam splitter prism.

10. The color management system claimed in claim 8, wherein the spatial light modulator is a liquid crystal on silicon panel.

11. The color management system claimed in claim 1, wherein the light combiner is a dichroic beam splitter.

12. The color management system claimed in claim 1, wherein the light combiner is an X-prism.
